(19) United States
(12) Patent Application Publication
(10) Pub. No.: US 2002/0168314 A1
(43) Pub. Date: Nov. 14, 2002

(54) Method of making expanded graphite with high purity and related products

(76) Inventor: Mike G. Roemmler, Los Angeles, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/802,707

(22) Filed: Mar. 8, 2001

(51) Int. Cl. C01B 31/04

(52) U.S. Cl. 423/448; 423/460

(57) ABSTRACT

A method and article of manufacture of purified expanded graphite formed by a method including expanding a graphite material from a first density to a smaller second density and following expansion, purifying the graphite material.

### BACKGROUND OF THE INVENTION

1. Field of the Invention

The invention relates to methods of purifying graphite.

2. Background

Methods of purifying graphite have been known for about 150 years. Historic literature describes the purification of natural graphite by using concentrated nitric acid, sulfuric acid and potassium chlorate or an acid mixture. See Brodie, M. B. C.: Ann. Chem. Phys. 3, 1855/Luzi, Willi German Patent No. 66804, 1891 /Olstowski, F. U.S. Pat. No. 3,333,941, 1067.

Natural graphite flake is a highly crystalline form of graphite. Expanded natural graphite is generally produced by combining graphite with an intercalation agent and thermal treatment of the intercalated graphite. The most common intercalation agent is concentrated sulfuric acid often mixed with a strong oxidizer like nitric acid or hydrogen peroxide. U.S. Pat. No. 3,494,382 describes a process of making expanded graphite that may be compressed into various shapes.

In addition to the acid treatment, expanded natural graphite (also described as graphite vermiculite or graphite worms) is generally obtained by the exposure of expanded graphite to heat of more than 200° C. Most common graphite expansion operations work at temperature levels of 800-1100° C. Graphite expands at these temperature levels 100-150 times from a bulk density of 0.5-0.7 g/cm³ to 0.002-0.02 g/cm³.

Natural graphite in crystalline flake form is commercially available in several purity levels. Most common are 90-94 percent carbon manufactured by floatation of graphite ore, or graphite varieties with a purity level of 95-99 percent obtained by a chemical purification process (e.g., HCl, NaOH, H₂SO4). Still higher purification levels (99.5-99.95 percent carbon) are obtained by either chemical treatment (HF) or thermal treatment 1500-3000° C. or both.

Highly purified graphite flakes are used for producing expanded graphite materials either in a form of a powder (for electrochemical applications) or as compacted expanded graphite (known as flexible graphite) for various industrial applications, including nuclear gasket material, crystal pulling of semiconductor materials, and support material for manufacturing of synthetic diamonds.

For electrochemical applications such as in alkaline batteries, the purity of the graphite is important to maximize the lifetime of a battery cell. Critical elements that degrade battery cell performance when present in the graphite are described in WO99/34673. These critical elements include antimony, arsenic, molybdenum, vanadium, chromium, iron, copper and tin.

U.S. Pat. No. 3,492,197 describes the use of expanded graphite powder mixed into a large variety of plastics (thermo-set and thermoplastic resins) to enhance electrical properties of the resins. Conductive resins are used in a large variety of electrostatic and shielding applications (e.g., ESD—electrostatic discharge, RFI—radio frequency interference, and EMI—electromagnetic interference).

U.S. Pat. No. 1,137,373 teaches that thermoplastic and thermoset binders mixed into the expanded graphite enhance the impermeability of the graphite part once compressed to flexible graphite rings or plates. Such plates are used in electrochemical applications as bipolar plates in redox batteries, fuel cells and electrolytic cells.

Typically the purification of natural graphite is focused at the stage of the unexpanded flake. The purification process can be a chemical treatment, a thermal treatment or a combination of both. Highly purified graphite flakes (e.g., carbon content 99.9) are commercially available from, for example, Kroptmühl AG, Germany, or Superior Graphite Co. of Chicago, Ill.

### SUMMARY OF THE INVENTION

A method of producing purified expanded graphite in the form of powders or various shapes like foils, sheets, rings, shells, etc. is described. The invention also relates to articles of manufacture made according to a method of producing purified graphite. In one embodiment, the method comprises an acid intercalation, expansion, compacting process of natural graphite starting with a carbon content of typically 98-99 percent carbon. The intercalation process is typically accomplished by mixing the graphite with an acid, such as fuming nitric acid and/or concentrated sulfuric acid at a ratio of 3:1. The expansion of the intercalated natural graphite is typically accomplished at a temperature level of 900-1000° C. The resulting expansion ratio is on the order of 100 to 150 and reflects a bulk density of the graphite of three to five grams per liter (g/l). The expanded graphite is then compacted to a density of 0.05 to 1.5 g/l to form a “sheet” or “block” like material that can be manually handled.

Following compacting, the prepared material is purified. In one embodiment, the prepared material is purified by a heat treatment in a vacuum furnace. The temperature is raised to a level of 1500 to 3000° C., typically to 2200° C., and held at that temperature depending on the amount of graphite in the furnace up to about 12 hours. For small amounts or lower density graphite, little (e.g., about 0.5 hours) or no holding time at the high temperature level is necessary. The vacuum heat treatment acts to purify the expanded graphite to impurity levels of about 30 to 500 ppm, typically about 80 to 150 ppm.

The described method leads to higher purity levels of the final graphite due to the purification of the graphite in its expanded state. Impurities of around 100 ppm can be accomplished from natural graphite grades with a carbon content of greater than 98 percent. Articles of the invention include high purity flexible graphite foil or sheets made from densified expanded graphite material. Another article of the invention is a high purity expanded graphite powder with a particle size of 2 to 2000 μm.

Additional features, embodiments, and benefits will be evident in view of the figures and detailed description presented herein.

### BRIEF DESCRIPTION OF THE DRAWINGS

The features, aspects, and advantages of the invention will become more thoroughly apparent from the following detailed description, appended claims, and accompanying drawings in which:

FIG. 1 is a flow chart of an embodiment of a method to form an article of manufacture of purified expanded graphite.

### DETAILED DESCRIPTION OF THE INVENTION

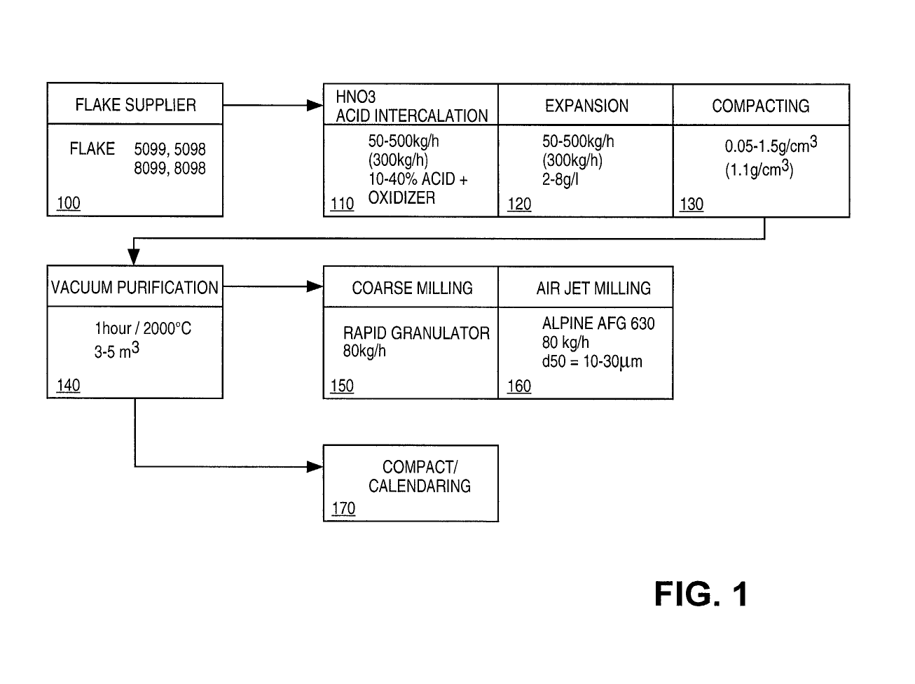

In one embodiment, the acid intercalation, expansion and the compacting of natural graphite flake in a sequential process, the vacuum heat treatment of the material and the alternate of either compacting the expanded graphite further to a higher density sheet product or the milling of the expanded graphite to small particles of 20 to 2000 microns (μm) is disclosed. FIG. 1 illustrates a representative flow scheme.

One raw material is natural graphite flake commercially available from China with a particle size of 32 to 320 mesh preferably 50 to 80 mesh, and an impurity level of ash on loss of ignition (LOI) of about 0.5 to 5 percent, preferably about 1 to 2 percent (block 100). Suitable grades include but are not limited to, grades represented by numerical codes 5099, 5098, 8099 and 8098. A representation “5099” generally means the natural graphite material has a 50 mesh particle size and a 99 percent carbon content. Analogous meanings may be attributed to the other suitable grades listed.

In one embodiment of a process of forming highly purified graphite for commercial uses, the natural graphite flake is initially fed into a continuous mixer where the graphite is mixed with an intercalation agent, such as a fuming nitric acid (HNO₃), at a rate of 50-500 kg/h, preferably 200-250 kg/h, and a graphite: acid ratio of typically about 3:1 (block 110). In one example, the residence time in the mixer is about 10-100 minutes preferably 20 to 40 minutes. It is to be appreciated that other intercalation agents may be used, including, but not limited to, concentrated sulfuric acid (H₂SO₄) or a mixture of HNO₃ and H₂SO₄.

After the residence time in the mixer, the acid-intercalated graphite material is fed into a gas burner having a temperature level of about 400 to 1200° C., preferably 800 to 1000° C. (block 120). The thermal treatment of a few seconds (e.g., one to five seconds) expands the graphite material to a light vermiculite with a density on the order of about 0.002 to 0.02 g/cm³ (bulk volume of 50-500 mL/g).

Following the thermal treatment, the expanded graphite is compacted, for example, by passing the material through a double belt press (block 130). After passing the double belt press, the expanded graphite is cut into sheets of 200 millimeters (mm)×200 mm to 2000 mm×2000 mm preferably to 1500 mm×1500 mm. The expanded graphite sheets are then stacked in about one to ten cubic meters (m³), preferably three to five cubic meters, piles.

Following compacting, the graphite piles are introduced into a vacuum furnace and subjected to a vacuum purification (block 140). A useful purification temperature for purifying graphite is about 1500 to 3000° C. One suitable temperature for this invention is about 1750 to 2400° C. Since the graphite is already expanded, the residence time at the purification temperature level can be reduced to a minimum. After the optimum temperature level is reached (which may be on the order, in one example, of 10 to more hours), in one embodiment, the furnace can be shut off and cooled down.

From the vacuum furnace, the purified product is then either further compressed by a calendaring process or in a hydraulic press (block 170) or it can be further processed to expanded graphite powder. To produce graphite powder, the expanded and purified graphite is fed into a rotary grinder, such as a RAPID GRANULATOR Model 2463K, commercially available from Rapid Granulator Inc. of Rockford, Ill. to reduce the particle size to approximately 0.3 to 3 mm preferably 1 to 2 mm (block 150). After passing the rotary grinder, the material may optionally be fed to a pin mill. The material is then fed into a fluidized bed air mill, such as the ALPINE model AFG630, commercially available from Alpine GmbH of Augsburg, Germany (block 160). The resulting product from the air mill has a particle size distribution, d50, of about 5-50 μm preferably about 10 to 30 μm.

### EXAMPLES

Table I compares impurity levels of a graphite flake in a prior art process where a thermal purification precedes acid intercalation and expansion and a process where thermal purification follows acid intercalation and expansion.

TABLE I

| | | Impurities of | Impurities of |
|---|---|---|---|
| | Impurities of | graphite flake | graphite flake |
| | graphite flake | after heat | after heat |
| | before heat | treatment before | treatment of |
| Element | treatment | acid intercalation | expanded graphite |
| Cu | 1.6 | 0.2 | 0.8 |
| Fe | 712 | 15.4 | 5.6 |
| Mo | 1.2 | 0.7 | 0.7 |
| Cr | 4.0 | 0.6 | 0.1 |
| Sn | 0.7 | 0.2 | 0.5 |
| V | 1.8 | 0.9 | 1.5 |
| Ash[%]* | 0.54 | 0.13 | 0.02 |

*Main residual impurities in the ash are Aluminum and Silicon.

Table II compares impurity levels of a graphite where the thermal purification process after expansion of the intercalated graphite was made under vacuum and with the introduction of an auxiliary gas of chlorine into the vacuum furnace. The expanded graphite product obtained by this kind of process shows even better purity levels. Typically, the expanded graphic product, purified under vacuum at high temperature and with an auxiliary gas of chlorine as a purification catalyst, contains not more than 10 ppm elemental impurities. Other suitable auxiliary gases include, but are not limited to, fluorine and freon. Elemental analysis was made with an ICP analyzer.

Table II compares impurity levels of a graphite flake in a prior art process where a thermal purification precedes acid intercalation and expansion, and a process where thermal purification in a vacuum with a chlorine atmosphere follows acid intercalation and expansion. Typically, the expanded graphite product, purified under vacuum with a chlorine atmosphere at high temperature contains not more than 10 ppm elemental impurities.

TABLE II

| | | Impurities of | Impurities of |
|---|---|---|---|
| | | graphite flake | expanded graphite |
| | Impurities of | after heat | after heat |
| | graphite flake | but before | treatment of |
| Element | before treatment | acid intercalation | chlorine atmosphere |
| Cu | 1.6 | 0.2 | <0.005 |
| Fe | 712 | 15.4 | 0.04 |
| Mo | 1.2 | 0.7 | 0.22 |
| Cr | 4.0 | 0.6 | <0.1 |
| Sn | 0.7 | 0.2 | 0.01 |
| V | 1.8 | 0.9 | 0.006 |
| Ash[%]* | 0.54 | 0.13 | <0.001 |

*Main residual elemental impurities are Aluminum and Silicon.

Prior art processes teach thermal purification prior to acid intercalation and expansion. By thermally purifying after expansion, the invention removes more impurities, such as copper (Cu), iron (Fe) chromium (Cr), aluminum (Al), and silicon (Si). Table I illustrates the improved purification.

In the preceding detailed description, the invention is described with reference to specific embodiments thereof. It will, however, be evident that various modifications and changes may be made thereto without departing from the broader spirit and scope of the invention as set forth in the claims. For example, the invention has generally been described with reference to a natural graphite process. It is to be appreciated that a similar process may be applied to an artificial graphite process with beneficial results. Still further, the purification is described as a thermal purification under vacuum. It is to be appreciated that other purification processes may be similarly suitable, including but not limited to, a purification by acid treatment such as with 30 percent hydrochloric acid. The specification and drawings are, accordingly, to be regarded in an illustrative rather than a restrictive sense.

What is claimed is:

1. A method comprising:
expanding a graphite material from a first density to a smaller second density; and
following expansion, purifying the graphite material.

2. The method of claim 1, wherein the graphite material comprises a natural graphite flake.

3. The method of claim 1, wherein expanding a graphite material comprises:
combining the graphite material with an intercalating agent.

4. The method of claim 3, wherein the intercalating agent is nitric acid.

5. The method of claim 4, wherein expanding the graphite material comprises:
combining the graphite material and the intercalating agent at a graphite material to intercalating agent at a ratio of about three to one.

6. The method of claim 3, wherein expanding the graphite material comprises, after combining the graphite material with the intercalating agent, subjecting the graphite material to a thermal treatment.

7. The method of claim 6, further comprising:
prior to purifying, compacting the graphite material.

8. The method of claim 6, wherein the thermal treatment comprises a first thermal treatment and purifying the graphite comprises subjecting the graphite material to a second thermal treatment under vacuum at a temperature in the range of 1500 to 3000° C.

9. The method of claim 8, wherein subjecting the graphic material to a second thermal treatment further comprises introducing an auxiliary gas into the vacuum environment.

10. The method of claim 9, wherein the auxiliary gas comprises chlorine.

11. The method of claim 1, further comprising:
following purifying, one of grinding and compacting the graphite material.

12. The method of claim 1, further comprising:
following purifying, compacting the graphite material; and
following compacting, grinding the graphite material.

13. A method comprising:
expanding a graphite material;
following expansion, compacting the graphite material; and
following compaction, purifying the graphite material.

14. The method of claim 13, wherein expanding a graphite material comprises:
combining the graphite material with an intercalating agent.

15. The method of claim 14, wherein the intercalating agent is nitric acid.

16. The method of claim 15, wherein expanding the graphite material comprises:
combining the graphite material and the intercalating agent at a graphite material to intercalating ratio of about three to one.

17. The method of claim 13, wherein expanding the graphite material comprises, after combining the graphite material with the intercalating agent, subjecting the graphite material to a first thermal treatment.

18. The method of claim 17, wherein purifying the graphite material comprises a second thermal treatment and the second thermal treatment comprises purifying under vacuum at a temperature in the range of 1500 to 3000° C.

19. The method of claim 17, wherein subjecting the graphic material to a second thermal treatment further comprises introducing an auxiliary gas into the vacuum environment.

20. The method of claim 19, wherein the auxiliary gas comprises chlorine.

21. The method of claim 13, further comprising:
following purifying, one of grinding and compacting the graphite material.

22. The method of claim 13, further comprising:
following purifying, compacting the graphite material; and
following compacting, grinding the graphite material.

23. The method of claim 13, wherein the graphite material comprises a natural graphite flake.

24. An article of manufacture comprising graphite formed according to a method comprising:
expanding a graphite material from a first density to a smaller second density; and
following expansion, purifying the graphite material.

25. The article of manufacture of claim 24, wherein expanding a graphite material comprises:
combining the graphite material with an intercalating agent.

26. The article of manufacture of claim 25, wherein the intercalating agent is nitric acid.

27. The article of manufacture of claim 24, wherein the graphite material comprises a natural graphite flake.
